(19) United States
(12) Patent Application Publication
(10) Pub. No.: US 2008/0275771 A1
(43) Pub. Date: Nov. 6, 2008

(54) Merchant transaction based advertising

(75) Inventor: Michael Levine, Corte Madera, CA (US)

Correspondence Address: TOWNSEND AND TOWNSEND CREW LLP, TWO EMBARCADERO CENTER, 8TH FLOOR, SAN FRANCISCO, CA, 94111, US

(73) Assignee: Visa U.S.A. Inc., San Francisco, CA (US)

(21) Appl. No.: 11/799,549

(22) Filed: May 1, 2007

(51) Int. Cl. G06Q 30/00

(52) U.S. Cl. 705/14; 705/16

(57) ABSTRACT

Methods and systems are disclosed for producing advertisements on a transaction record for a transaction between a consumer and a merchant involving the use of a portable consumer device such as a credit or debit card. Advertisers may specify criteria so that the advertisements are specifically targeted.

### CROSS-REFERENCES TO RELATED APPLICATIONS

Not Applicable

### BACKGROUND

In a typical payment transaction, a consumer receives a transaction record such as a receipt as proof of the transaction. The transaction record most often is provided in physical printed form, although in recent years electronic transaction records have become increasingly prevalent.

The practice of placing advertisements on such transaction records is known. For example, it has long been common for reels of receipt paper used by grocery stores to have advertisements and/or coupons printed on the back, so that each transaction record includes advertising. These ads are not particularly well targeted to the consumer, however, as they are issued on an essentially random basis.

In more recent years, the practice of providing dynamic advertising on transaction records has grown. For example, more and more grocery stores have begun using information about a consumer's purchasing patterns to deliver advertisements which are more targeted to the interests of the particular consumer. For example, a sustained pattern of buying pet supplies by a particular consumer may lead to advertisements or coupons for pet food being included on that consumer's transaction record.

This more modern practice has the advantage of delivering ads which are more likely to be of interest for a particular consumer. However, the practice has its limitations. For example, the advertisements are typically limited to products offered by the merchant generating the transaction record. Further, the information used to target the advertisements is limited to that gathered by the merchant itself.

A need thus exists to allow outside advertisers greater access to this advertising medium, and to leverage additional personal information about a consumer which may not be available to a particular merchant in order to provide more precisely targeted advertisements. Further, merchants that allow third-party advertisements to be delivered to their customers via their transaction records may need a means of filtering out advertisements from direct competitors, and from entities with whom the merchants do not wish to be associated.

Embodiments of the invention addresses these and other problems, collectively and individually.

### BRIEF SUMMARY

Embodiments of the invention are directed to systems and methods for receiving advertisements from advertisers which are specifically targeted at consumers, and causing these advertisements to appear on transaction records for transactions such as payment transactions, money transfers, etc. The advertisements can be selected using information that relates to financial accounts which are used by the consumers. These financial accounts may be associated with portable consumer devices such as credit cards, electronic tokens used on the Internet, etc.

In embodiments of the invention, the use of portable consumer devices is preferred. However, electronic tokens such as passwords, or other information known to the consumer may also be used in embodiments of the invention.

One embodiment of the invention is directed to a method. The method comprises receiving an advertisement and advertisement selection criteria from an advertiser, and receiving information relating to a transaction involving a portable consumer device that is used by a consumer and an access device associated with a merchant. The information is derived from an authorization request message that is sent from the merchant to an issuer associated with the portable consumer device. If the information meets the advertisement selection criteria, then the advertisement is sent to the access device.

Another embodiment of the invention is directed to a method. The method comprises using a portable consumer device to interact with an access device to purchase a good or service offered by a merchant. The access device thereafter sends an authorization request message to an issuer of the portable consumer device. Information (e.g, the type of portable consumer device or the credit limit associated with the portable consumer device) derived from the authorization request message is received, and if the information meets predetermined advertisement selection criteria, a predetermined advertisement is selected and is sent to the access device along with an authorization response message. The authorization response message and the advertisement are received at the access device.

Another embodiment of the invention is directed to a method. The method comprises interacting with a portable consumer device during a transaction, sending an authorization request message to an issuer of the portable consumer device, where information derived from the authorization request message is used to select an advertisement based on predetermined criteria. An authorization response message is received from the issuer, and the advertisement is also received if the information meets the predetermined criteria. The authorization response message and the advertisement are then provided to the consumer.

Another embodiment of the invention is directed to a method for receiving criteria identifying advertisements (or advertisers associated with the advertisements) that a merchant does not want to appear on transaction records generated by the merchant.

Other embodiments of the invention are directed to systems, computer readable media, access devices, etc. incorporating such methods.

These and other embodiments of the invention are described in more detail below.

### BRIEF DESCRIPTION OF THE DRAWINGS

FIG. 1 is a block diagram showing a system according an embodiment of the invention.

FIG. 2 is a flow-chart showing a method according an embodiment of the invention.

FIG. 3 is a flow-chart showing a method according another embodiment of the invention.

FIG. 4 is an illustration of a transaction record with an advertisement.

FIG. 5 is a block diagram showing subsystems in a typical computer apparatus.

### DETAILED DESCRIPTION

In embodiments of the invention, an organization such as a payment processing organization (e.g., Visa) can host or work with a third party to host an online advertising directory. Advertisers can use the online directory to select demographic groups of consumers for targeted ad campaigns. The advertisers could pay a fee to have their advertisements “narrowcast” to consumers (e.g., credit or debit cardholders) during transactions that are conducted by the consumers. Similarly, the advertisers may use the online directory to select particular merchants to target with ad campaigns. The service may require a targeted merchant to give permission before ads appear on its transaction records.

Advertisements include banners, rewards, coupons, etc. associated with goods or services offered by advertisers. Advertisements may also include the names of the advertisers. In addition to being focused on a particular merchant, consumer, or class of consumers, the advertisements could also be selected based on time or geographic constraints (e.g., an advertisement for a TV show in a particular time zone).

In a typical payment transaction, a consumer can purchase a good at a merchant using a credit card or some other portable consumer device. At checkout time, either a POS (point of sale) terminal at the merchant or an online terminal in communication with the merchant could send an authorization request message to an issuer of the credit card requesting approval for the transaction. Shortly thereafter, the issuer decides whether or not the transaction is approved and an authorization request message is sent by the issuer and is received by the merchant. The authorization response message indicates whether or not the transaction is approved or not approved. The sending of the authorization request message and the receiving of the authorization response message may be part of a transaction authorization process.

During the transaction authorization process, a payment processing organization that facilitates communication between the merchant and the issuer can communicate with or operate a server computer that operates or has access to an ad server which has obtained criteria for selecting advertisements for consumers from the online directory. For example, the ad server may determine that the consumer is using a “gold” card, which is only used by high net-worth individuals. The ad server may then select an advertisement for a luxury good and may modify the authorization response message that is sent back to the merchant to include the selected advertisement. The POS terminal or the online terminal may thereafter produce a transaction record, which includes the authorization response message and the advertisement (e.g., “this transaction has been brought to you by Mercedes Benz™”) that was dynamically targeted to the consumer. The dynamic targeting may be based on criteria that the advertiser paid for and selected in the online advertising directory. In preferred embodiments, advertising impressions may be reported back to the advertiser.

In embodiments of the invention, either the POS terminal or online receipt could feature an image and/or text from the advertiser. The POS terminal may have a high quality printer that is able to print color receipts with the advertisement. If the transaction record is in the form of an electronic, online document, then the online advertisements could also link to advertisers' Web sites.

Although the advertisements that are generated for the consumers may or may not directly relate to a merchant's business (e.g., an ad for a luxury car may be printed on a receipt at a grocery store), the merchant can still benefit from embodiments of the invention. For example, during the merchant fee calculation cycle (i.e., when fees for conducting the transactions are assessed), advertising revenues could be applied to offset the merchant's transaction costs (e.g, $1000 in merchant fees with a $100 offset for providing advertising outside of the merchant's business space to consumers). The online directory, ad server or any other component could also contain logic to ensure that competing merchants could not advertise to merchants where the sales transaction originated.

Embodiments of the invention have a number of advantages. For example, compared to conventional dynamic ad placement processes, entities such as payment processing organizations can use information about consumers that traditional merchants do not use to select targeted ads. Such information may be derived from a portable consumer devices that are used by consumers and/or authorization request messages that are generated using the portable consumer devices. Examples of such information may include the bank that issued a credit card, the income level of the consumer, the credit limit of the consumer, etc. Such information is currently not being used to dynamically select advertisements for consumers. Furthermore, the dynamically placed ads can be located on transaction records such as credit card receipts. Transaction records such as credit card receipts typically do not have any advertising printed on them.

Also, in embodiments of the invention, a merchant may also have the opportunity to filter out certain types of advertisements. For example, most merchants would prefer that advertisements from direct competitors not be shown to their customers. In another example, merchants may also want to filter out advertisements for particular industries, or with undesirable subject matter such as gambling advertisements, etc.

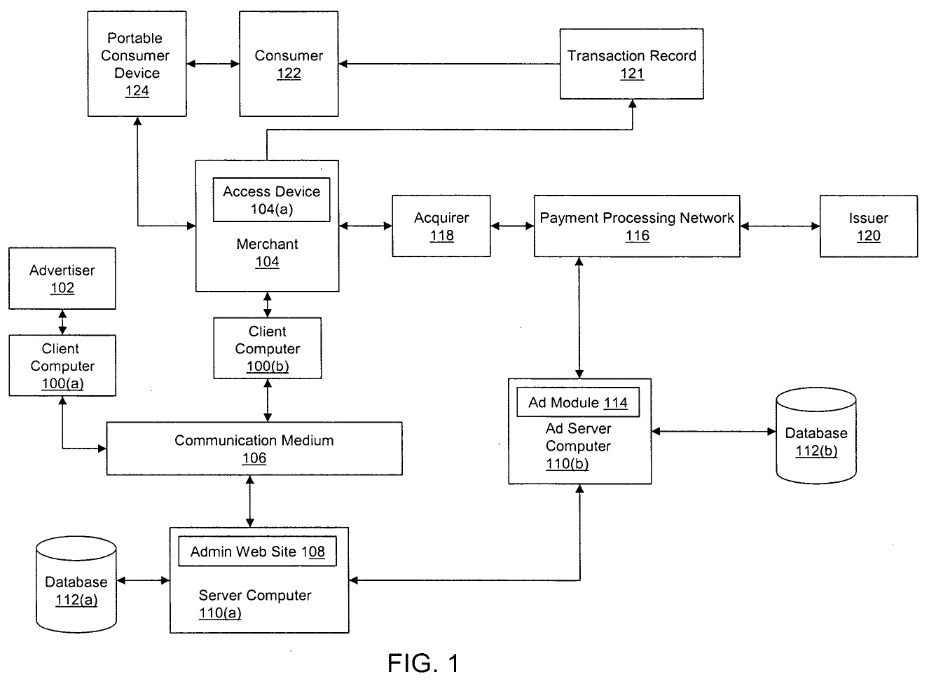

FIG. 1 is a block diagram showing a system according to an embodiment of the invention. The system includes one or more client computers 100(a), 100(b) in operative communication with a server computer 110(a) operating an administrative Web site 108, via a communication medium 106. The administrative Web site 108 may contain an online advertising directory, which allows an advertiser 102 to create, manage, and/or monitor ad campaigns.

The first client computer 100(a) can be used by the advertiser 102 to access the administrative Web site 108 in order to upload and/or select advertisement images or text that will eventually be present on transaction records. The first client computer 100(a) may also be used by the advertiser 102 to specify criteria that can be used to identify consumers or sets or types of consumers that are intended to see the advertiser's advertisements.

The second client computer 100(b) can be used by a merchant 104 to communicate with the administrative Web site 108 on the server computer 110(a). For example, in some embodiments, the merchant 104 may want to identify advertisers the merchant 104 wishes to block from advertising to its customers.

The first and second client computers 100(a), 100(b) may include any suitable commercially available computation apparatuses with suitable commercially available Web browsers. Suitable client computers include Windows™ based computers.

The merchant 104 may have or be associated with an access device 104(a). Suitable access devices include point of sale (POS) devices, cellular phones, PDA, personal computers (PCs), tablet PCs, handheld specialized readers, set-top boxes, electronic cash registers (ECR), automated teller machines (ATM), virtual cash registers (VCR), kiosks, security systems, access systems, and the like. The access device 104(a) may have one or more output devices such as printers and/or display devices for printing or displaying transaction records. The access device 104(a) could also be remotely located with respect to the merchant 104. For example, the access device 104(a) could be a personal computer operated by the consumer 122, which is in communication with the merchant 104 via the Internet.

The server computer 110(a) may have access to a first database 112(a) which may contain code for ad campaigns that advertisers may select from and/or code for tools for allowing advertisers to create their own ad campaigns. The server computer 110(a) may be operated by, or affiliated with, a payment processing organization or some other suitable entity.

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server. A server computer services the requests of one or more client computers, or even other server computers.

The server computer 110(a) may also directly or indirectly communicate with an issuer 120, a payment processing network 116, and an acquirer 118. The issuer 120 is typically a business entity (e.g., a bank) which issues portable consumer devices such as credit or debit cards consumers. The consumer 122 may have an account with the issuer 120. The acquirer 118 is typically a business entity (e.g., a bank) which handles financial transactions involving use of portable consumer devices for the merchant 104. The merchant 104 may have an account with the acquirer 118. Some entities may be both an acquirer and an issuer at the same time and embodiments of the invention encompass such entities.

The communication medium 106 may use any suitable wired or wireless network, including the Internet. Although the communication medium 106 is shown as being separate from the server computer 110(a) in FIG. 1, the communication medium 106 may alternatively include the server computer 110(a) in other embodiments. The communication medium 106 may also comprise a payment processing network 116 such as VisaNet (described below) in some embodiments.

The system further comprises an ad module 114 running on an ad server computer 110(b). The ad server computer 110(b) may be in operative communication with the payment processing network 116 and the server computer 110(a). It may have access to a second database 112(b), which contains criteria for determining which particular advertisements are to be sent with authorization response messages that pass back to the merchant 104.

While FIG. 1 depicts the ad server computer 110(b) as being separate from and in operative communication with the server computer 110(a) running the Web site 108, the ad module 114 could alternatively run on the same server computer 110(a) as the administrative Web site 108, and may use the first database 112(a). In such embodiments, the server computer 110(a) may also perform the functions of the ad server computer 110(b).

The ad server computer 110(b) is in operative communication with a payment processing network 116, such as VisaNet. Suitable payment processing networks can process ordinary credit and debit card transactions, and can clear and settle transactions on a daily basis. The payment processing network 116 is in operative communication with the issuer 120 and the acquirer 118.

The system may also comprise a portable consumer device 124 that is used by a consumer 122 to initiate a transaction with the merchant 104. The transaction is typically initiated after some interaction with the access device 104(a), which will eventually produce a transaction record 121, including an advertisement, for the consumer 122. The transaction record 121 may comprise a physical written record, or an electronic record.

The portable consumer device 124 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit or prepaid devices (e.g., a debit card or prepaid card), credit devices (e.g., a credit card), or stored value devices (e.g., a stored value card).

It is understood that the block diagram in FIG. 1 is simplified for simplicity of illustration. In other embodiments, there may be more or less components than are specifically illustrated in FIG. 1.

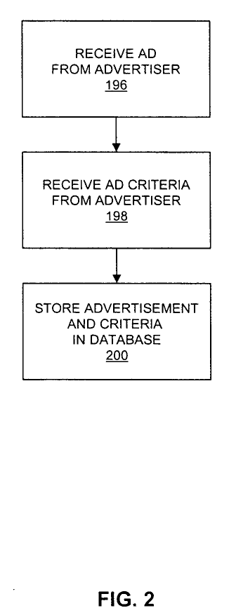

FIG. 2 is a flow chart showing a method according to an embodiment of the invention. The method can be performed by a server computer that is operated by a payment processing organization or some other suitable entity.

Referring to FIGS. 1 and 2, an advertisement is received by the ad server computer 110(b) from an advertiser 102 and is stored in the database 112(b) (step 196). For example, the advertisement may be received by the ad server computer 110(b) from the server computer 110(a) after it is created by the server computer 110(a). The advertisement could alternatively be received by the ad server computer 110(a) by being created using the ad server computer 110(b). In a specific embodiment, the advertisement may be sent by the advertiser to a payment processing organization via postal mail, email, or any other suitable communication method, and may be uploaded to the ad server computer 110(b).

As noted above, the advertisement that is eventually present on the transaction record 121 that is received by the consumer 122 may be in any suitable form. It may be in paper form, or may be in electronic form. It may comprise text, images, or a combination of both. The advertisement may also be in color or black-and-white.

The advertisement may be sent to the merchant 104 in any suitable manner. The selected advertisement (i.e., code for the selected advertisement) will typically be relayed to and stored by the ad module 114 for future delivery to the merchant 104 via the payment processing network 116. Alternatively, in other embodiments, code for images or text associated with the advertisement may be stored to the access device 104(a) in advance. In such embodiments, the ad module 114 will identify advertisements that are pre-stored in the access device 104(a) rather than sending the ads themselves to the merchant 104. A lookup table or other suitable identification mechanism could be used to link an advertisement stored in an access device 104(a) and an advertisement identifier sent with an authorization response message.

Before or after providing advertisements, the advertiser 102 then provides criteria identifying the consumers that it wants to see its advertisements (step 198). The criteria could be supplied to the ad server computer 110(b) and stored in the database 112(b) in any of the ways described above for the advertisements. Such criteria can encompass information relating to the consumer 122 and/or the consumer's portable consumer device 124. For example, exemplary criteria include, without limitation, an annual income, geographic location, purchasing pattern, credit score range, type of portable consumer device (e.g., a “gold” card, a “platinum card”, or an ordinary card), the particular bank associated with the consumer, the merchant that is associated with the consumer, the types of goods or services being purchased, etc. Any of these criteria, in any suitable combination, may be used in embodiments of the invention to dynamically select advertisements to put on a transaction record 121.

Note that by using ad selection criteria such as type of portable consumer device, geographic location, etc., a class of consumers can be targeted without customizing advertisements down to the individual consumer level. For example, by identifying a portable consumer device as a “gold card” that is used by high income individuals, an advertisement can target a particular class of consumer rather than a specific consumer. This is particularly desirable where consumer privacy may be an issue.

Also, it is noted that advertisers may pay higher fees to a payment processing organization or other entity to “compete” for space on transaction records. For example, a first advertiser may pay a payment processing organization a higher fee than a second advertiser. The first advertiser's advertisement may be placed on more transaction records or more frequently than the second advertiser's advertisement. Alternatively, because the first advertiser paid a higher fee than the second advertiser, the first advertiser's advertisement may be placed on transaction records before the second advertiser's advertisement is placed on transaction records.

In the next step 200, the ad criteria and the selected ads are stored in a database 112(b) for use with subsequent transaction authorization processes.

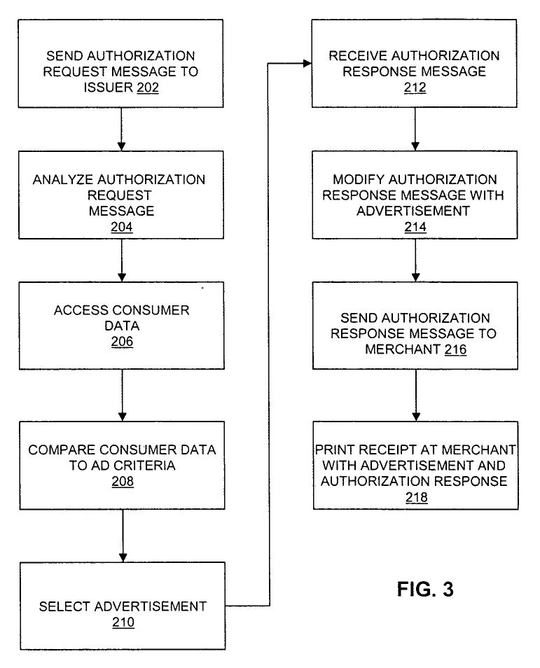

An exemplary transaction authorization process is described with respect to FIG. 3. FIG. 3 shows a flowchart illustrating a transaction authorization process according to an embodiment of the invention.

In a typical purchase transaction, a consumer 122 may go to a merchant 104 to purchase a product (e.g., gasoline) with the consumer's portable consumer device 124 (e.g., a credit card). At the merchant 104, the consumer 122 may use his portable consumer device 124 to interact with an access device 104(a) which may reside at (e.g., a POS terminal in a checkout lane at a merchant) or otherwise be associated with (e.g., a portable computer that has the merchant's Web site running on it) the merchant 104. For example, if the portable consumer device 124 is a credit card, then the consumer 122 or a clerk that works at the merchant 104 may swipe the credit card through the access device 104(a).

Then, the access device 104(a) sends an authorization request message to the issuer 120 via the merchant acquirer 118 and the payment processing network 116 to request approval for the purchase transaction (step 204). The authorization request message may include information such as the amount of the purchase, the merchant ID, the PAN (primary account number) and its associated issuer BIN (bank identification number), and other information.

As the authorization request message passes through the payment processing network 116, the ad server computer 110(b), which is in communication with the payment processing network 116 may analyze the authorization request message. For example, using the information derived from the authorization request message (e.g., portable consumer device type, merchant location, transaction amount, issuing bank, etc.), the payment processing network 116 may cause the ad server computer 110(b) to access consumer data in the database 112(b) (step 206), compare the consumer data to ad criteria stored in the database 112(b) (step 208), and then select an appropriate advertisement for this transaction and for this consumer 122 (step 210). The information that is used to select the advertisement may be obtained from the authorization request message, and/or may have been previously gathered from prior transactions conducted by the consumer 122, and stored by the payment processing network 116 in the database 112(b). For example, the authorization request message may simply identify an account number associated with a portable consumer device. Using the account number, other, pre-stored information about the consumer (e.g., age, height, address) may be used to select an advertisement for the consumer.

Illustratively, the authorization request message may indicate that the portable consumer device 124 is a “gold card” and is reserved for consumers with credit limits of $20,000 and above, and those that generally have high income. Using this information, the ad server computer 110(b) may compare this consumer data to ad criteria stored in the database 112(b). An example of ad criteria may include a rule such as: provide a luxury car ad such as a Mercedes Benz™ ad on a transaction record if the portable consumer device used is associated with a credit limit of $20,000 or more. The Mercedes-Benz™ ad may then be selected by the ad server computer 110(b).

After the ad is selected, the authorization response message may be received and then modified by the payment processing network 116 (steps 212 and 214). In one embodiment, while the ad server computer 110(b) is determining which advertisement to select for the consumer 122, the authorization request message may be sent to the issuer 120 for approval. When the authorization response message is sent by the issuer 120 and is received by the payment processing network 116, the authorization response message may thereafter be modified to include the selected advertisement (i.e., code for an advertisement or code identifying an advertisement is included with the authorization response message). Once the authorization response message is modified, it may then be forwarded to the merchant 104 (step 216). This process is efficient, since the advertisement selection process and the decision as to whether or not to authorize the transaction can occur in parallel.

In another embodiment, the advertisement can be first selected by the ad server computer 110(b) and can be used to modify the authorization request message that will pass to the issuer 120. Then, the modified authorization request message can be sent to the issuer 120. The issuer 120 can approve or not approve the transaction and an authorization response message with the authorization response and the advertisement can be forwarded to the merchant 104 via the payment processing network 116 and the acquirer 118.

In yet another embodiment, the authorization request message can be sent from the merchant 104 to the issuer 120 via the acquirer 118 and the payment processing network 116. The issuer 120 may then authorize or not authorize the transaction. The issuer 120 may then send an authorization response message back to the merchant 104 via the acquirer 118 and the payment processing network 116. The ad server computer 110(b) may thereafter select an advertisement (as explained above) and may modify the authorization response message that is sent to the merchant 104 so that the selected advertisement is included with the authorization response message.

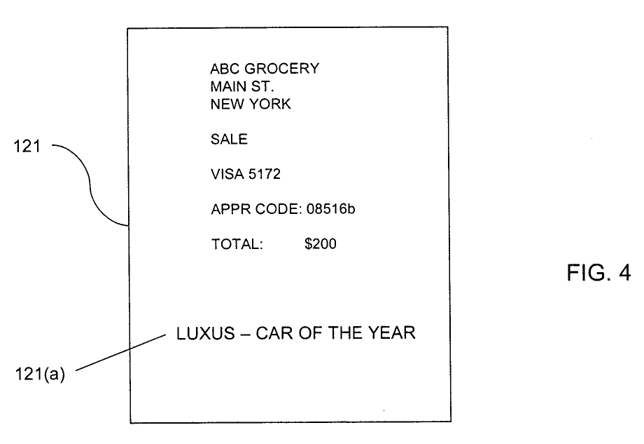

Once the authorization response message with the selected advertisement is received at the merchant 104, the authorization response message indicating approval or disapproval of the transaction and the selected advertisement may be printed by the access device 104(a) (step 218). An example of a printed transaction record 121 (e.g., a receipt) is shown in FIG. 4. In FIG. 4, reference number 121(a) refers to an example of a dynamically placed advertisement for a luxury car.

While the ad selection process takes place between the issuer 120 and the acquirer 118 in the above example, it is understood that the ad selection process could alternatively take place at the issuer 120 or even the acquirer 118 in other embodiments of the invention.

In other embodiments of the invention, the merchant 104 can specify criteria identifying advertisements which the merchant 104 wishes to block from being delivered to its customers. The criteria may be delivered in a variety of ways as with the advertiser criteria. The criteria could, for example, block all advertisements from direct competitors of the merchant, or businesses with whom the merchant does not wish to be associated. For example, a children's store may not wish to receive advertisements from makers of alcoholic beverages. The criteria could also identify specific types of advertisement that are acceptable and/or not acceptable. For example, a toy merchant may wish to allow grocery stores to advertise, but not allow advertisements for alcoholic beverages. The logic or computer code needed to perform these functions may reside in the ad server computer 110(b) or in any other component in the system.

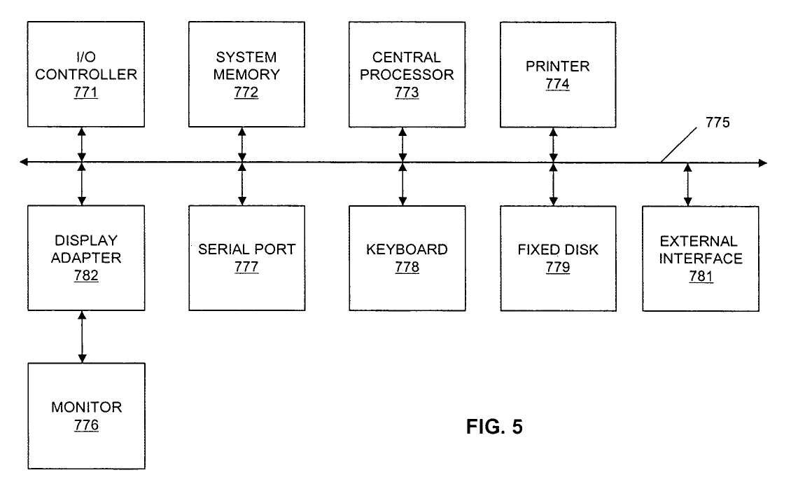

FIG. 5 shows typical components or subsystems of a computer apparatus. Such components or any subset of such components may be present in various components shown in FIG. 1, including the access device 104(a), server computer 110(a), the ad server computer 110(b), client computers 100(a), 100(b), or any component. The subsystems shown in FIG. 4 are interconnected via a system bus 775. Additional subsystems such as a printer 774, keyboard 778, fixed disk 779, monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus 775 allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

Any of the above-described methods or steps of such methods may be embodied as software code to be executed by a processor of the server computer or any other suitable combination of devices using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM.

It should be understood that the present invention can be implemented in the form of control logic, in a modular or integrated manner, using software, hardware or a combination of both. Based on the disclosure and teachings provided herein, a person of ordinary skill in the art will appreciate other ways and/or methods to implement the present invention.

Any of the above-described embodiments and/or any features thereof may be combined with any other embodiment(s) and/or feature(s) without departing from the scope of the invention.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

What is claimed is:

1. A method comprising:
receiving an advertisement and advertisement selection criteria from an advertiser;
receiving information relating to a transaction involving a portable consumer device or an electronic token that is used by a consumer and an access device associated with a merchant, wherein the information is derived from an authorization request message sent from the merchant to an issuer associated with the portable consumer device or electronic token;
determining if the information meets the advertisement selection criteria; and
if the information meets the advertisement selection criteria, then sending the advertisement to the access device.

2. The method of claim 1 wherein the advertiser is one of many advertisers that pays a fee, wherein the advertiser pays more for the advertisement than the other advertisers.

3. The method of claim 1 wherein the selection criteria includes at least one of the type of merchant, the issuing bank, the type of portable consumer device or electronic token that is being used, and an income level of the consumer.

4. The method of claim 1 wherein the authorization request message was previously sent from the merchant to the issuer via an acquirer associated with the merchant and a payment processing network.

5. The method of claim 1 further comprising:
receiving the authorization request message; and
sending the authorization response message back to the access device.

6. The method of claim 1 wherein the access device is a point of sale terminal.

7. A computer readable medium comprising computer code for performing the method of claim 1.

8. A server computer comprising the computer readable medium of claim 7.

9. A method comprising:
using a portable consumer device or electronic token to interact with an access device to purchase a good or service offered by a merchant, wherein the access device thereafter sends an authorization request message to an issuer of the portable consumer device or electronic token, and wherein information derived from the authorization request message is received, and if the information meets predetermined advertisement selection criteria, a predetermined advertisement is selected and sent to the access device along with an authorization response message; and
receiving the authorization response message and the advertisement at the access device.

10. The method of claim 9 wherein the access device is a point of sale terminal.

11. The method of claim 9 wherein the transaction is a payment transaction and the portable consumer device is a payment card.

12. The method of claim 9 wherein the criteria includes at least one of the type of merchant, the issuing bank, the type of portable consumer device or electronic token that is being used, and an income level of the consumer.

13. A method comprising:
interacting with a portable consumer device or electronic token during a transaction;
sending an authorization request message to an issuer of the portable consumer device or electronic token, wherein information derived from the authorization request message is used to select an advertisement based on predetermined criteria;
receiving an authorization response message from the issuer, and the advertisement, if the predetermined criteria are met by the information; and
providing the authorization response message and the advertisement to the consumer.

14. The method of claim 13 wherein the criteria includes at least one of the type of merchant, the issuing bank, the type of portable consumer device or electronic token that is being used, and an income level of the consumer.

15. The method of claim 13 wherein the criteria includes a specific type of portable consumer device.

16. A computer readable medium comprising code for performing the method of claim 13.

17. A POS terminal comprising the computer readable medium of claim 16.

18. A system comprising:
means for receiving an advertisement and advertisement selection criteria from an advertiser;
means for receiving information relating to a transaction involving a portable consumer device or electronic token that is used by a consumer and an access device associated with a merchant, wherein the information is derived from an authorization request message sent from the merchant to an issuer associated with the portable consumer device or electronic token;
means for determining if the information meets the advertisement selection criteria; and
if the information meets the advertisement selection criteria, then sending the advertisement to the access device.

19. A system comprising:
means for interacting with a portable consumer device or electronic token during a transaction;
means for sending an authorization request message to an issuer of the portable consumer device or electronic token, wherein information derived from the authorization request message is used to select an advertisement based on predetermined criteria;
means for receiving an authorization response message from the issuer, and the advertisement, if the predetermined criteria are met by the information; and
means for providing the authorization response message and the advertisement to the consumer.
